(19) United States
(12) Patent Application Publication
(10) Pub. No.: US 2006/0038747 A1
(43) Pub. Date: Feb. 23, 2006

(54) Display device with electron beam guiding channels

(75) Inventors: Willem Lubertus Ijzerman, Eindhoven (NL); Michel Cornelis Josephus Marie Vissenberg, Eindhoven (NL); Hubertus Maria Rene Cortenraad, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., 5621 BA Eindhoven (NL)

(21) Appl. No.: 10/518,256

(22) PCT Filed: Jun. 4, 2002
(86) PCT No.: PCT/IB03/02483

§ 371 Date: Dec. 16, 2004

(30) Foreign Application Priority Data
Jun. 25, 2002 (EP) 02077523.5

(51) Int. Cl. G09G 3/20

(52) U.S. Cl. 345/55

(57) ABSTRACT

A display device is provided with electron beam guiding channels (10). A channel (10) receives an electron beam (EB) and guides the beam (EB) parallel to a luminescent display screen (40). The electron beam (EB) is extractable from the channel (10), after which the beam (EB) impinges on the display screen (40). Electrode means (11, 12, 13) defining an electric potential in the channel (10) are provided for guiding and extracting the electron beam (EB). The electrode means (11, 12, 13) are arranged in such a way that in the channel (10), the electron beam (EB) is focused in a transverse direction being perpendicular to the channel (10) and parallel to the display screen (40). Thus, the electron transmission of the beam guiding channel (10) can be particularly high.

The invention relates to a display device, comprising:
an electron source for generating an electron beam;
a luminescent display screen for receiving an electron beam and displaying image information;
electron beam guiding means for guiding said electron beam to said display screen, said electron beam guiding means comprising a beam guiding channel extending essentially in a guidance direction parallel to the display screen and being provided with electrode means defining, in operation, a beam guiding electric potential in the channel.

Display devices based on the Cathode Ray Tube (CRT) are widely known in the art. Advantages of CRTs are the fact that the required materials and technologies are established and well understood, a high luminescence efficiency, the relatively easy feasibility of gray scales in the displayed image and a fast response time allowing display of moving images without motion artifacts.

However, most known CRTs have a relatively large depth. Therefore, efforts have been made to create a “flat” CRT, having a depth comparable to that of, for instance, a Liquid Crystal Display. The display device as described in the opening paragraph is a “flat” CRT. An embodiment of such a display device is known from patent US-A-4,153,856. In the known display device, an electron gun generates an electron beam, which is injected into a beam guide at a beam injection point. Subsequently, the electron beam is guided through said beam guide in a guidance direction. The beam guide is formed between a first and a second guide grid, both extending substantially parallel to the display screen. A third guide grid is present at close distance from the second guide grid, facing the display screen, and also extending parallel to the screen. Each guide grid is provided with beam passing apertures, and is connected to a common electric potential.

As seen from the beam guide, extraction electrode stripes are provided behind the first guide grid. These extraction electrode stripes normally receive a voltage allowing guidance of the electron beam in the beam guide. The electron beam is extracted from a position within the beam guide by changing the voltage supplied to the extraction electrode stripes. The extracted electron beam is guided further so as to impinge on the display screen.

The display screen comprises a plurality of picture elements (pixels) arranged in rows and columns. A beam guide is provided for each column of pixels, whereby the electron beam is extractable from predetermined positions within the beam guide, said positions corresponding to pixels arranged on the rows.

However, in the known display device, noticeable variations are observed in the brightness of the displayed image, particularly in the direction corresponding to the guidance direction of the beam guide.

It is therefore an object of the invention to provide a display device as described in the opening paragraph, which has an improved image brightness uniformity.

To achieve this object, a display device according to the invention is characterized in that the electrode means are arranged to focus the electron beam in a transverse direction that is substantially orthogonal to the guidance direction, and parallel to the display screen.

The invention is based on the recognition that the observed brightness variations are caused by a relatively large transmission loss of the guided electron beam. This transmission loss is caused by a defocusing of the electron beam causing a relatively large number of electrons to be lost from the guided beam. As a consequence, these electrons do not reach the display screen.

The number of lost electrons grows with an increase of the distance through which the electron beam is guided. Therefore, at a position relatively far from the beam injection point, the beam current is reduced as compared to the beam current of the electron beam at the beam injection point, so that the beam current of the electron beam at the display screen is dependent on the distance through which the electron beam is guided. The brightness of the luminescent pixel is dependent on the beam current of the electron beam impinging on the pixel. Therefore, image brightness variations occur between different pixels of the display screen, in particular between pixels on opposing sides of the display screen.

The electron beam defocusing is caused by a disturbance of the guiding electric potential in the beam guide. The display screen is at a relatively high anode voltage, usually 5 kV or more. This anode potential permeates into the beam guide, thereby disturbing the guiding electric potential.

While the grid structure as known in the known display device does compensate for a potential disturbance in the direction perpendicular to the display screen and the guide grids, and symmetrizes and focuses the electric potential in that direction, no such action is provided in the transverse direction. In the transverse direction, the electron beam is insufficiently confined, so that, during passing of the electron beam through the beam guide, a relatively large number of electrons is lost from the beam.

By suitably arranging the electrode means, an electron optical lens can be formed, which also has lens action in the transverse direction. This lens can be used to symmetrize the electric potential in the transverse direction, and focus the electron beam in the transverse direction. Due to the transverse lens action, the confinement of electrons within the beam is improved, and a transmission loss of the electron beam guide is reduced.

In a preferred embodiment, the electrode means comprise a first electrode having a base portion parallel to the display screen, and side portions extending from said base portion in a direction perpendicular to the display screen. Because of the extending side portions, such a first electrode can form the electron optical lens having lens action in the transverse direction.

In a preferred embodiment, the side portions are positioned at both edges of the base portion as seen in the transverse direction, the side portions extending towards the display screen.

The first electrode now has a U-shaped profile with right angles. It defines the boundary of the channel at the side facing away from the display screen and partially encloses the guided electron beam.

This embodiment operates particularly well when the U-shaped profile is aligned symmetrically to the path of the electron beam, so that the distances from the path of the electron beam to the side portions is substantially equal for both side portions. Thus, the electric potential within the channel is particularly well symmetrized.

Preferably, the channel is formed between adjacent barrier ribs of a first insulating plate, provided with conducting traces being part of the electrode means.

This embodiment is relatively easy to manufacture. A separate first guide grid, as present in the prior art, is no longer required. Part of the electrode means is formed by the conducting traces laid out on the first insulating plate. Moreover, if the conducting traces are laid out perpendicularly to the channel, a first electrode having the preferred U-shaped profile with right angles is automatically obtained without additional manufacturing steps.

A guide grid structure as known from the prior art may be provided between the first insulating plate and the display screen.

However, more advantageously, the first insulating plate is put together with a second insulating plate facing the display screen, provided with an extraction aperture for extracting the electron beam from the channel, and having conducting traces being part of the electrode means.

The known display device is difficult to manufacture, because it comprises three relatively thin guide grids, which have to be mounted at a close distance from each other. Moreover, to ensure the stability of the beam guiding channel, this distance should be substantially constant throughout the display screen. Therefore, stringent requirements are imposed on mounting and alignment of the guide grids.

According to this preferred embodiment, the beam guiding channel is formed between two insulating plates. The electric potential inside the channel can be applied by means of conducting traces laid out on the plates. It is possible to lay out the conducting traces with high precision during manufacture, for instance by using a mask. The number of components required to manufacture the beam guide is reduced, and the prior art problem of obtaining a good alignment of the guide grids is overcome.

The electron beam guide is assembled by stacking together the insulating plates. At least part of the conducting traces on the first plate may contact associated conducting traces on the second plate, when the plates are assembled. Preferably, the conducting traces are substantially perpendicular to the channel.

Generally, the channel comprises a plurality of cells, and the display screen comprises a plurality of picture elements (pixels) arranged in rows and columns. A channel corresponds, for instance, to a column of pixels, and a cell of said channel then corresponds to a pixel of the display screen. The second insulating plate is provided with an extraction aperture for a cell, through which aperture the electron beam travels from the electron beam guiding channel towards the display screen.

In a preferred embodiment, the electrode means comprise a second electrode between a cell and an adjacent cell, said second electrode being provided with a beam passing aperture. In operation, the electron beam passes through the aperture in the second electrode from the cell to the adjacent cell, when the cell is not selected. By means of the combination of the first and second electrode, the electron is focused particularly well in the transverse direction. In general, both a first electrode and a second electrode are provided for each cell, the electric potential being periodic with the cells.

The periodic electric potential defines a path, along which the electron beam travels. Generally, the second electrodes are at a relatively high positive voltage for this purpose. Therefore, they have a preferably small thickness, so as to avoid that electrons land on the second electrodes.

A preferred embodiment is characterized in that the second electrode cooperates with the first electrode for modifying the electric potential in a selected cell, so as to extract the electron beam from said selected cell towards the display screen.

In a display device, it is desired that the electron beam is scanned throughout the display screen in order to display an image. Therefore, the electron beam should subsequently impinge on each picture element of the screen. In order to guide the electron beam to a predetermined pixel, the cell corresponding to that pixel is selected by modifying the electric potential in said cell.

The electron beam is first guided parallel to the display screen, until it reaches the selected cell. In the selected cell, the electron beam is deflected at a substantially right angle, and passes through the extraction aperture of the selected cell. The electron beam is now guided perpendicularly to the display screen, and focused onto the predetermined pixel.

In this preferred embodiment, the extraction of the electron beam is efficient, so that a relatively large part of the electrons is extracted from the selected cell. Moreover, the required switching voltages that are applied to the first and second electrode are low as compared to the switching voltage applied to the prior art extraction stripes. The first and second electrodes are provided within the cell, whereas in the prior art the beam guide is shielded from the extraction stripes by one of the guide grids.

Preferably, the selected cell comprises an electron optical mirror within the selected cell, said mirror being placed, for instance, at a 45-degree angle with the guidance direction. Forming an electron optical mirror is a particularly efficient way of extracting the electrons. It can be realized by suitably setting the voltages supplied to the first electrode and the second electrode in the selected cell.

Generally, in a selected cell the voltages applied to the first and second electrodes are more negative as compared to a cell through which the beam is guided, so as to repel the electron beam and push the beam through the extraction aperture. The exact orientation of the electron optical mirror can be tuned by means of the switching voltages supplied to the first and second electrodes. Thus, the electron beam can be directed through the extraction aperture as satisfactorily as possible, so that a particularly high extraction efficiency is realized.

In a preferred embodiment, the electrode means comprise a third electrode extending at least around an extraction aperture in the second insulating plate.

The third electrode has the effect of symmetrizing the electric potential inside the beam guide in the direction perpendicular to the display screen. It reduces the permeation of the anode voltage into the beam guiding channel. In general, a third electrode is provided near each extraction aperture.

A preferred embodiment is characterized in that two electron beams are injected at opposing ends of the channel.

Because of the symmetry of the beam guiding channel, it does not matter at which end an electron beam is injected. This fact can be used advantageously by simultaneously injecting an electron beam at both ends of the channel. Thereby, for instance, two pixels of the display screen can be addressed at the same time, so that the number of switches for modifying the electric potential in the cells is halved. The electron beam from one end may be used for pixels having an odd line number, and the electron beam from the other end may be used for pixels having an even line number.

It is preferred that the electron beam guiding means comprise positioning means for positioning the electron beam extracted from the selected cell onto an associated picture element.

After the electron beam has been guided to the selected cell, it is extracted from the beam guiding channel towards the display screen. Since a cell has a specific picture element associated with it, it should be ensured that the beam, after being extracted, is positioned onto said picture element.

A cell may be associated with a single picture element. Then, preferably, the positioning means comprise a plurality of conducting plates being provided with apertures for passing the electron beam from the selected cell to the associated single picture element on the display screen.

The conducting plates are provided with intermediate voltages between the voltage of the third electrode and the anode voltage. By means of the conducting plates, the electrons are accelerated towards the display screen, while at the same time the electron beam is focused, so that the spot of the electron beam on the display screen is relatively small and well-focused.

The plurality of conducting plates is preferably separated from each other by means of insulating plates, so that the positioning means comprise a stack of alternating insulating and conductive plates. The insulating plates are also provided with apertures for passing the electron beam. The apertures between a cell and its associated picture element should be aligned as satisfactorily as possible, so that an unrestricted passage of the electron beam is ensured.

The display device generally operates under vacuum conditions to avoid the collision of electrons with gases inside the display device as much as possible. For this purpose, the display device should comprise a vacuum support so that it can withstand the external atmospheric pressure. It is an advantage of the stack of insulating and conducting plates that it acts as an integrated vacuum support.

Alternatively, a cell corresponds to a plurality of picture elements. The positioning means should then preferably be arranged to position the electron beam onto a preselected one of said plurality of picture elements.

The electron beam may, for instance, be deflected towards one of the picture elements by means of an electrostatic deflector on the screen-facing side of the extraction aperture.

The plurality of picture elements is, for example, arranged as a tile, such as a 4×4 or 8×8 block. Also, they may comprise a number of subpixels each corresponding to a different primary phosphor color.

These and other aspects of the display device according to the present invention will now be elucidated with reference to the accompanying drawings. Herein:

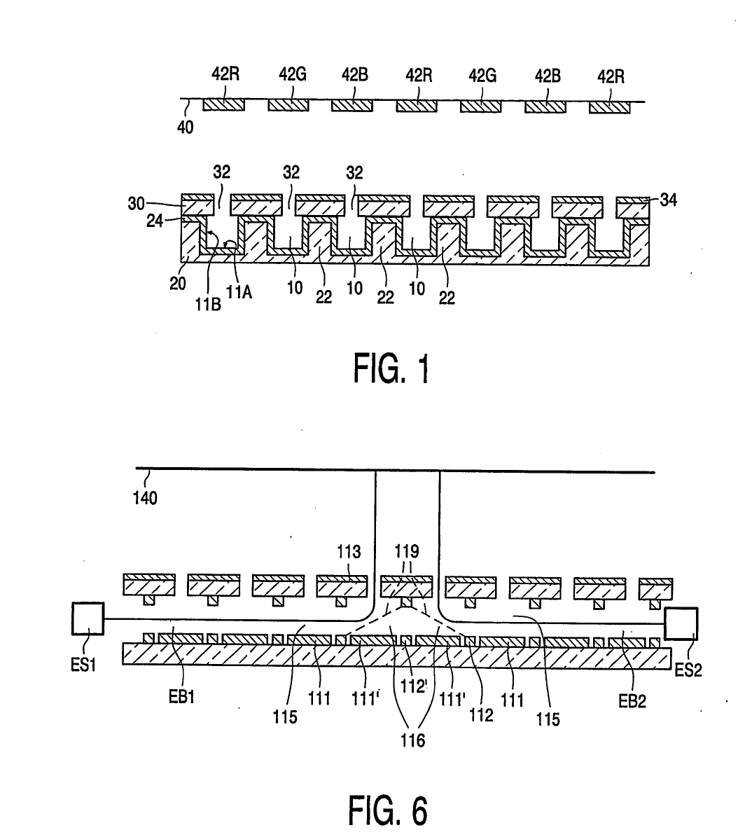

FIG. 1 is a preferred embodiment of the display device;

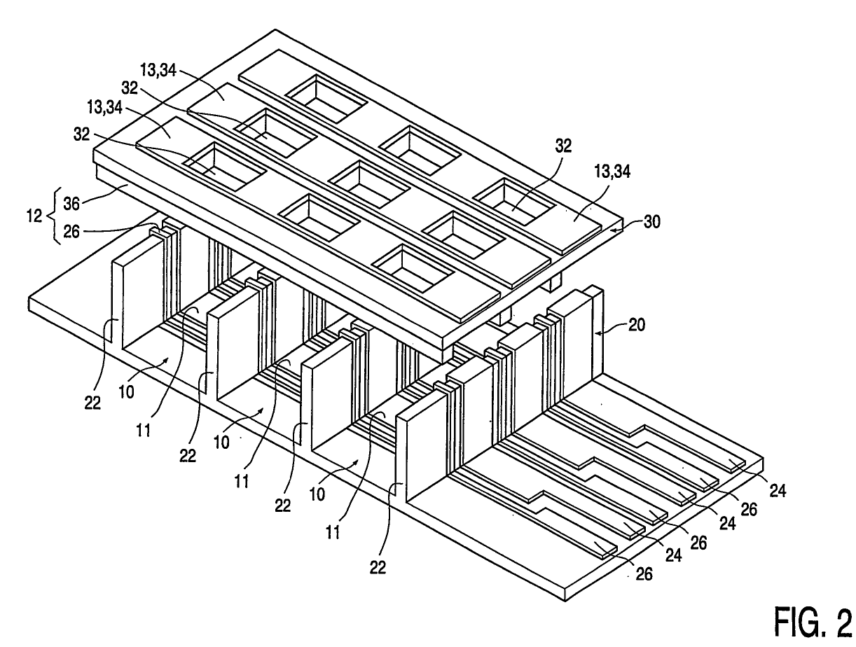

FIG. 2 is a more detailed, isometric view of a preferred embodiment of the display device;

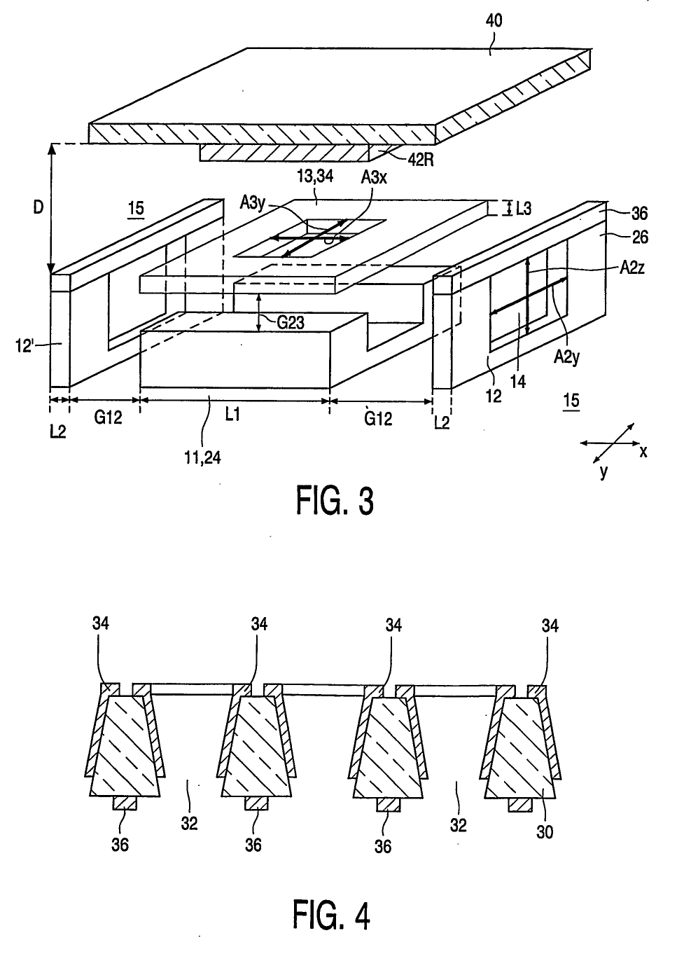

FIG. 3 shows the electrode means for a single cell of an electron beam guiding channel;

FIG. 4 is a cross-section of the selection plate;

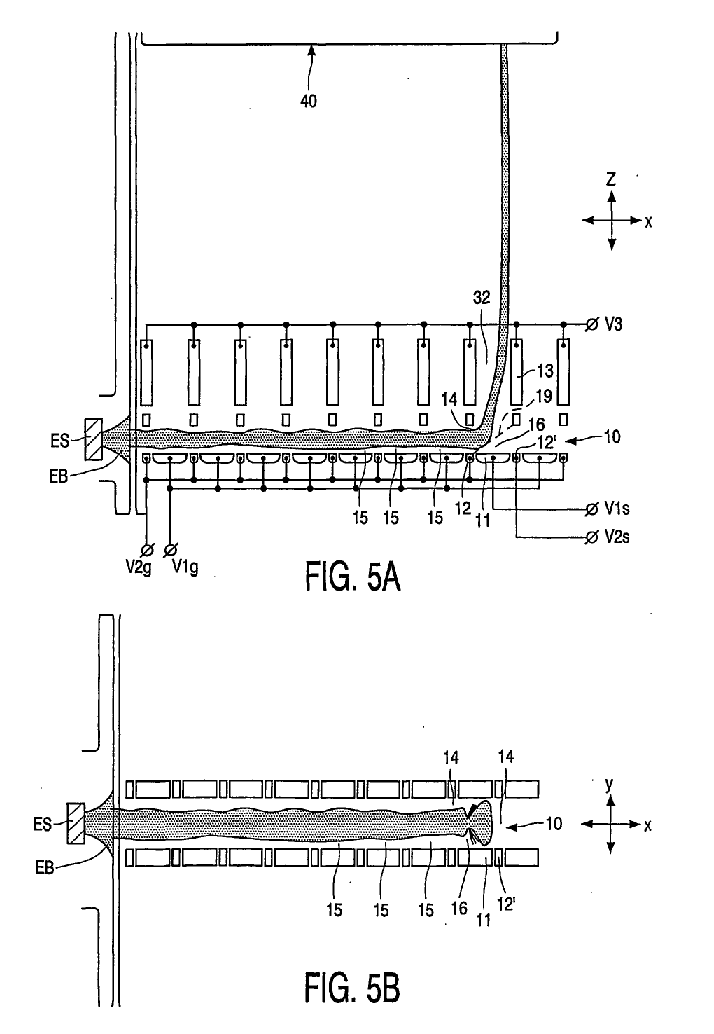

FIGS. 5A and 5B show an electron beam guiding channel of the preferred embodiment in operation;

FIG. 6 is an alternative embodiment of the display device;

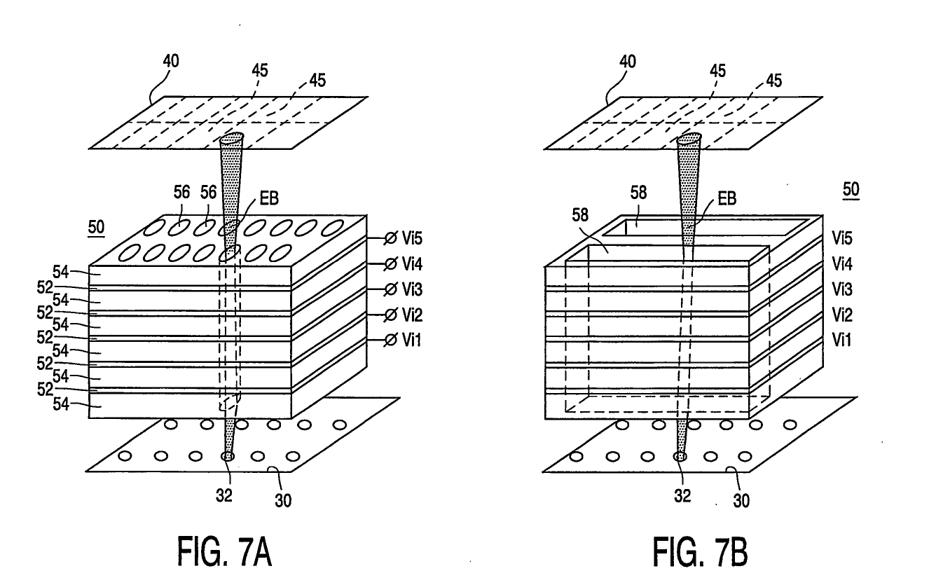

FIGS. 7A and 7B show embodiments of a vacuum support suitable for use in the display device;

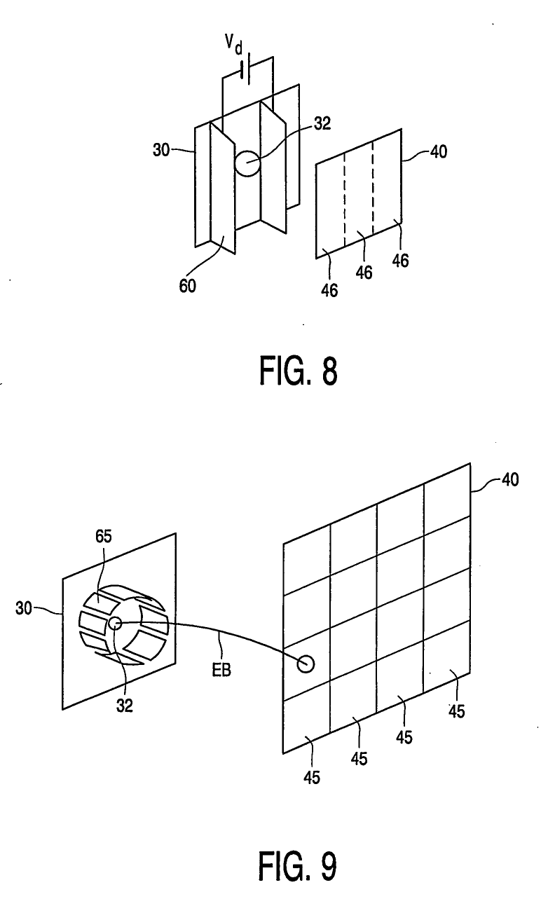

FIG. 8 shows part of the selection plate with a single beam extraction aperture, corresponding to a color picture element comprising three color sub-pixels, and

FIG. 9 shows part of the selection plate with a single beam extraction aperture, corresponding to a 4×4 tile of picture elements.

FIG. 1 is a cross-section of a preferred embodiment of the display device. The display device comprises a display screen 40 at the front, which screen is provided with phosphor tracks 42R, 42G, 42B in three primary colors: red, green and blue. On the opposing (back) side, a structure comprising electron beam guiding channels 10 is provided.

Each channel 10 corresponds to a single phosphor track 42R, 42G, 42B. The channels 10 extend in the same direction as the phosphor tracks 42R, 42G, 42B. Generally, the display device is provided with an electron source ES for each channel 10. The electron source ES injects an electron beam EB into the beam guiding channel 10. The channel 10 guides the electron beam EB parallel to the display screen 40.

The structure comprising the channels 10 has two insulating plates 20, 30. At regular distances, the insulating plate 30 that is closest to the display screen 40 is provided with beam extraction apertures 32, through which the electron beam EB can be extracted from the beam guiding channel 10 and passed onto a phosphor track 42R, 42G, 42B of the display screen 40. At a landing position of the electron beam EB, the display screen 40 illuminates.

The preferred embodiment is shown in more detail in FIG. 2. A first insulating plate, the channel plate 20, is provided with barrier ribs 22. A channel 10 is defined between two adjacent barrier ribs 22, said channel 10, in operation, guiding the electron beam EB. The diameter of the channel 10 in the transverse direction (y-direction) is determined by the distance between adjacent barrier ribs 22, which is, for example, 150 micrometer. The height of the barrier ribs 22 is, for example, also 150 micrometer, and their thickness in the transverse direction is 50 micrometer.

Conducting traces 24, 26 are laid out on the channel plate 20. In operation, the conducting traces 24 form the first electrodes (bottom electrodes) 11 of the beam guiding channel 10.

The channel plate 20 is assembled with a second insulating plate, which is the selection plate 30. For clarity reasons, the selection plate 30 is drawn here at a small distance from the channel plate 20, whereas in reality the plates are stacked together and are in direct contact.

Conducting traces 34 are laid out on the side of the selection plate 30 facing the display screen 40. A plurality of beam extraction apertures 32 is provided in the selection plate 30, extending all the way through the plate and the conducting traces 34. The selection plate 30 should be relatively thin, in order to allow efficient extraction of the electron beam EB from the channel 10. For example, the selection plate 30 has a thickness of 400 micrometer.

The beam extraction apertures 32 are arranged in rows and columns. A single aperture 32 corresponds either to a single picture element 45 of the display screen 40, or to a tile of picture elements. As seen from the display screen 40, a row or a column of apertures 32 is aligned with a channel 10, and is enclosed by a conducting trace 34. The conducting traces 34 are arranged symmetrically with respect to the beam extraction apertures 32, and form, in operation, the third electrodes (top electrodes) 13 of the beam guiding channel 10.

Also, conducting traces 36 are laid out on the side of the selection plate 30 facing the channel plate 20, with adjacent conducting traces 36 flanking a row of beam extraction apertures 32. When assembled, the conducting traces 36 contact the associated conducting traces 26 of the channel plate 20, for forming the second electrodes (channel electrodes) 12 of the beam guiding channel 10. The beam guiding channel 10 is divided into a plurality of cells 15, a cell 15 being defined to be a part of the channel 10 between two adjacent channel electrodes 12.

For a single cell 15, the electrode means are shown in more detail in FIG. 3. The cell 15 is bordered in the direction of the channel 10 (the x-direction) by adjacent channel electrodes 12, 12′. A channel electrode comprises conducting traces 26 on the channel plate 20 and conducting traces 36 on the selection plate 30, and is provided with an electron beam passing aperture 14. The diameter of this aperture in the transverse direction (A2y) equals the channel diameter in this direction, for example 150 micrometer. In the perpendicular direction, the diameter (A2z) equals the height of the barrier ribs 22, which is, for example, also 150 micrometer.

The bottom electrode 11 is formed by means of the conducting traces 24 on the channel plate 20, and has a rectangular U-shape. It comprises a base portion 11A, and side portions 11B extending from the base portion 11A towards the display screen 40. The side portions 11B extend from the edges of the base portion 11A, as seen in the transverse direction.

The base portion 11A is formed by the conducting trace 24 at the bottom of the channel 10, and the side portions 11B are formed by the conducting traces 24 on the flanges of the barrier ribs 22. Therefore, the height of the side portions 11B is substantially equal to the height of the barrier ribs 22, for example 150 micrometer. The shape of the bottom electrode 11 allows, in association with the channel electrode 12, a particularly good focussing of the electron beam EB in the transverse direction.

The top electrode 13 is formed by means of the conducting traces 34 on the side of the selection plate 30 facing the display screen 40. It is provided with a beam extraction aperture 32, which extends all the way through the selection plate 30. The top electrode 13 has a thickness L3, and the diameter of the beam extraction aperture 32 is A3x in the channel direction, and A3y in the transverse direction.

The selection plate 30 can be made of glass and the beam extraction apertures 32 can be constructed by means of powder blasting, so that they have a tapered shape. The conducting traces 36 that are part of the channel electrodes 12, 12′ are deposited, for instance, by means of a lithographic process.

The top electrode 13 preferably extends partly through the beam extraction apertures 32, towards the other side of the selection plate 30. The top electrode 13 partially covers the inside walls of the beam extraction aperture 32 in the selection plate 30. The effective thickness of the top electrode 13 is increased. For providing such a top electrode 13, a cataphoretic deposition process may be applied. Care should be taken that there are no short cuts between the top electrode 13 and the bottom electrode 11 or the channel electrode 12.

In the x-direction, the bottom electrode 11 extends through a length L1, and the channel electrodes 12, 12′ have a thickness L2. The bottom electrode 11 is separated from the channel electrodes 12, 12′ by a gap having a length G12.

The bottom electrodes 11 and the channel electrodes 12 have connector parts 17, 18 for supplying addressing voltages to the electrodes. As can be seen in FIG. 2, the connector parts 17,18 are preferably arranged on one side of the display device and can be structured in such a way that the connector parts have approximately the same contact area for both bottom electrodes 11 and channel electrodes 12.

Particularly efficient dimensions for the electrode structure are:

| | | |
|---|---|---|
| L1 | 600 | micrometer |
| L2 | 100 | micrometer |
| L3 | 50 | micrometer |
| G12 | 50 | micrometer |
| A2x | 150 | micrometer |
| A2y | 150 | micrometer |
| A3x | 150 | micrometer |
| A3y | 150 | micrometer |

In this example, the diameter of a cell 15 in the guidance direction is 700 micrometer. The diameter of a cell 15 in the transverse direction can be similar. If the beam guiding channel 10 is to be used in a color display device, the diameter of a cell 15 in the transverse direction can be reduced, for instance to 250 micrometer. In this direction, the only restriction in decreasing the diameter is given by the diameter A2y of the beam passing aperture in the channel electrodes 12.

FIGS. 5A and 5B schematically show an electron beam EB, which is injected into a beam guiding channel 10, and subsequently guided through the channel 10 and extracted from the channel 10. In FIG. 5A, the electron beam EB is shown in the guidance (x-) and perpendicular (z-) directions, and in FIG. 5B the electron beam EB is shown in the guidance (x-) and transverse (y-) directions.

In operation, separate addressing voltages are supplied to the different electrodes. The potential distribution that is thus obtained is periodic with the cells 15. The voltage being supplied to the top electrodes 13 can be fixed, while the voltages supplied to the bottom electrode 11 and the channel electrode 12 are preferably variable.

If a cell 15 is in a guiding state, the periodic potential defines a path in the channel 10, along which the electrons travel. The permeation of the potential of a channel electrode 12 to the adjacent channel electrode 12′ creates a path in the channel direction, along which the electron beam is guided from the beam passing aperture 14 in the channel electrode 12 to the beam passing aperture 14 in the adjacent channel electrode 12′. The top electrode 13 and the bottom electrode 11 are arranged to focus the electron beam EB in the z-direction (perpendicular direction) and the y-direction (transverse direction), respectively. It is clear from the Figures that the electron beam EB is particularly well focused in these directions, inside the beam guiding channel 10.

For any cell 15, the voltages supplied to the bottom electrode 11 and the channel electrode 12 in that cell can be varied, so that the cell 15 is brought into a selected state 16. The electron beam is extracted from the selected cell 16 through the beam extraction aperture 32, and travels towards the display screen 40.

For this purpose, the bottom electrode 11 is biased at a lower potential, to push the electron beam EB upwardly. The adjacent channel electrode 12′, which is the channel electrode 12 behind the selected cell 16, is also biased at a lower potential. In association with the bottom electrode 11, the adjacent channel electrode 12′ now forms an electron optical mirror 19, which is essentially a tilted zero-potential plane within the selected cell 16. The tilt angle of this electron optical mirror 19 is, for instance, 45 degrees, but it can be tuned by means of the potentials supplied to the bottom electrode 11 and the adjacent channel electrode 12′, in such a way that the electron beam EB is deflected towards the beam extraction aperture 32 as satisfactorily as possible. The ability to adjust the orientation of the electron optical mirror 19 allows a high extraction efficiency.

Preferred values for the addressing voltages are:

| | | | |
|---|---|---|---|
| V1g | (V1 guiding) | 40 | Volt |
| V1s | (V1 selected) | 5 | Volt |
| V2g | (V2 guiding) | 110 | Volt |
| V2s | (V2 selected) | −5 | Volt |
| V3 | | 40 | Volt |

The electron beam guiding channel 10 as described above has been tested, using these addressing voltages. An electron beam EB with a beam current of 30 microAmpere was injected into a channel 10 comprising ten subsequent cells. With all cells in the guiding state, the beam current of the guided beam, and thus the transmission efficiency of the ten cells, was larger than 99 percent. When the ninth cell was switched to the selected state 16, i.e. the electron beam was extracted from the ninth cell, the beam current of the extracted beam, and thus the extraction efficiency, was also larger than 99 percent.

The voltage swings required to change the bottom electrode 11 and the channel electrode 12 from the guiding to the selected state are therefore relatively low, in this example 35 Volt and 115 Volt, respectively. The driving electronics for addressing the pixels can therefore be relatively simple and cheap.

Preferably, a “line at the time” addressing scheme is applied. In this scheme, each pixel in a row is addressed at the same time, by selecting the cells 15 of the channel 10 that correspond to the pixels 45 in that row. After a predetermined time, the row is switched off by deselecting the corresponding cells 15, and the next row of pixels is addressed.

Preferably, the pixel addressing scheme is a pulse width modulation scheme. The amount of light that each pixel 35 emits is then determined by the period of time during which the electron source for the channel 10 corresponding to that pixel 35 is activated.

In an alternative embodiment, two electron sources are provided on opposing sides of a channel 110. The channel 110 and electrode means 111, 112, 113 are of a similar construction as those in the first embodiment of the display device. It is easy to switch two adjacent cells 115 to the selected state 116 at the same time, by supplying both their bottom electrodes 111′ with V1s and supplying the channel electrode 112′ in between said two cells with V2s. In both cells, an electron optical mirror 119 is formed, as shown in FIG. 6.

If an electron source is provided at both ends of the channel 110, two adjacent rows of pixels of the display screen 140 are now addressable simultaneously. For instance, an electron source ES1 at the beginning of the channel 110 can be used to supply a first electron beam EB1 to an odd row of pixels, and an electron source ES2 at the end of the channel 110 can be used to supply an electron beam EB2 to an even row of pixels.

This alternative embodiment has the advantage that the number of switches to change the voltages supplied to the bottom electrodes 111 and channel electrodes 112 is halved.

In thin vacuum display devices, such as the display device according to the present invention, a vacuum support is generally required to withstand the external atmospheric pressure. The proposed beam guiding channels 10, formed between the channel plate 20 and the selection plate 30, are self-supporting. However, an additional vacuum support is generally required between the selection plate 30 and the display screen 40.

Embodiments of vacuum supports are widely known in the art. A simple embodiment of a vacuum support is a so-called spacer plate. Such a plate provides a plurality of electrically insulating spacers between the selection plate 30 and the display screen 40. FIGS. 7A and 7B show two embodiments of a vacuum support 50, which are especially suitable for use in a display device according to the invention.

The vacuum support 50 comprises a stack of alternating conducting layers 52 and insulating layers 54. In this example, five conducting layers 52 and six insulating layers 54 are drawn, but any suitable number can be used. The thickness of all layers is drawn equal, but in a real display the thicknesses may vary. For example, the thickness of the insulating layers 54 may gradually increase from the selection plate 30 to the display screen 40.

In the first embodiment, holes 56 are provided, extending all the way through the stack, for passing the extracted electron beam to the display screen 40. In the second embodiment, the stack of layers 52,54 is provided with slits 58 for passing the electron beam. The slits generally extend in the direction of the phosphor stripes 42R, 42G, 42B on the display screen 40.

The conducting layers 52 receive focusing voltages Vi1 through Vi5. The voltages Vi1 . . . Vi5 increase from the beam guiding channel 10 to the display screen 40, to accelerate the electrons in the beam. Also, the voltages Vi1 . . . Vi5 are used to focus the electron beam between the beam guiding channel 10 and the display screen 40. The focusing of the electron beam results in a particularly small spot on the display screen 40. It has been shown that the number of electrons that are lost by impinging on the inner wall of the holes 56 or the slits 58 is negligible.

The focusing voltages Vi1 . . . Vi5 are, for instance, 400, 1000, 1600, 2500 and 3400 Volts, in that order, the display screen 40 being at an anode voltage Va of for instance 4000 Volts.

It is troublesome to further decrease the dimensions of the cells 15 and the electrode means from the above-mentioned values. This would lead to a relatively complicated manufacture. However, if the display device has a high image resolution, for example in a computer monitor having XGA or UXGA resolution, the pixel size decreases. It is then advantageous if the cells 15 have larger dimensions than the pixels 45 on the display screen 40, so that the dimension of the cells 15 can remain the same.

For this purpose, each cell 15 of the electron beam guiding channel 10, and each beam extraction aperture 32, now corresponds to a plurality of (sub-)pixels 45. Therefore, the number of cells no longer has a 1:1 relation with the number of pixels on the display screen, and thus with the image resolution of the display device.

An embodiment of this, wherein each pixel 45 comprises three color sub-pixels 46R, 46G, 46B, arranged in-line in the horizontal direction, is shown in FIG. 8 for a single beam extraction aperture 32 and pixel 45.

This embodiment is particularly advantageous for use in a color display device, in which each subpixel 46R, 46G, 46B corresponds to one of the phosphor colors red, green and blue. The sub-pixels 46R, 46G, 46B are relatively close to each other, so that a viewer observes the three sub-pixels as one color pixel, while at the same time the cell dimension of beam guiding channel 10 can remain unchanged in this embodiment.

Between the beam extraction aperture 32 and the display screen 40, selection means are applied for positioning the electron beam EB onto a preselected one of the sub-pixels 46R, 46G, 46B. In the embodiment shown in FIG. 8, conventional electrostatic deflection plates 60 are provided as selection means, which deflect the electron beam exiting from the beam extraction aperture 32 to one of the sub-pixels 46R, 46G, 46B. The sub-pixels are selectable by switching a deflection voltage Vd between the electrostatic deflection plates 60.

In this embodiment, if the deflection voltage Vd is 0 Volt, the electron beam is not deflected and impinges on the green sub-pixel 46G. If the deflection voltage is, for instance, −200 Volt, the electron beam is deflected to the left, as seen from the display screen 40, and impinges on the red sub-pixel 46R. If the deflection voltage is, for instance, +200 Volt, the electron beam is deflected to the right as seen from the display screen 40, and impinges on the blue sub-pixel 46B.

It is alternatively possible that each cell 15 corresponds to a tile of pixels 45, for instance a 3×3 or a 4×4 tile of pixels, or a 9×3 or a 16×4 tile of color sub-pixels in a color display device. This is shown in FIG. 9 for a tile comprising 4×4 pixels.

Selection means are provided between the beam extraction aperture 32 in the selection plate 30 and the display screen 40, so as to deflect the electron beam extracted from a cell 15 to a preselected one of the pixels of the tile corresponding to the cell 15.

In this embodiment, the selection means comprise an electrostatic multipole deflector 65 as commonly known in the state of the art. By means of the electrostatic multipole deflector 65, the electron beam is deflectable in both the x- and the y- direction.

The drawings are schematic and not drawn to scale. In the drawings, embodiments of the display device are shown with only a few pixels for simplicity reasons, whereas an actual display device would have, for instance, 800×600×3 color sub-pixels corresponding to SVGA resolution, or 720×576×3 color sub-pixels corresponding to PAL resolution.

Any insulating surface, most notably the parts of the channel plate 20 and selection plate 30 not covered by conducting traces 24, 26, 34, 36, and the vacuum support 50, may be provided with a conductive coating having high electrical resistivity. This prevents charging of the insulating surfaces, which may degrade the operation of the beam guiding channel.

While the invention has been described in connection with preferred embodiments, it should be understood that the invention should not be construed as being limited to the preferred embodiments. It includes all combinations of elements described therein, and variations which could be made thereon by a skilled person, within the scope of the appended claims.

In summary, the present invention relates to a display device provided with electron beam guiding channels (10). A channel (10) receives an electron beam (EB) and guides the beam (EB) parallel to a luminescent display screen (40). The electron beam (EB) is extractable from the channel (10), after which the beam (EB) impinges on the display screen (40). Electrode means (11, 12, 13) defining an electric potential in the channel (10) are provided for guiding and extracting the electron beam (EB). The electrode means (11, 12, 13) are arranged in such a way, that, in the channel (10), the electron beam (EB) is focused in a transverse direction perpendicular to the channel (10) and parallel to the display screen (40). Thus, the electron transmission of the beam guiding channel (10) can be particularly high.

1. A display device, comprising:
an electron source for generating an electron beam;
a luminescent display screen for receiving the electron beam and displaying image information;
electron beam guiding means for guiding said electron beam to said display screen, said electron beam guiding means comprising a beam guiding channel extending essentially in a guidance direction parallel to the display screen and being provided with electrode means defining, in operation, a beam guiding electric potential in the beam guiding channel,
characterized in that the electrode means are arranged to focus the electron beam in a transverse direction that is substantially orthogonal to the guidance direction, and parallel to the display screen.

2. A display device as claimed in claim 1, characterized in that the electrode means comprise a first electrode having a base portion parallel to the display screen, and side portions extending from said base portion in a direction perpendicular to the display screen.

3. A display device as claimed in claim 2, characterized in that the side portions are positioned at both edges of the base portion as seen in the transverse direction, the side portions extending towards the display screen.

4. A display device as claimed in claim 1, characterized in that the display device is provided with a first insulating plate having barrier ribs and being provided with conducting traces being part of the electrode means, the channel being defined between adjacent barrier ribs of the first insulating plate.

5. A display device as claimed in claim 4, characterized in that the display device comprises a second insulating plate between the first insulating plate and the display screen, said second insulating plate being provided with beam extraction apertures for extracting the electron beam from the channel, and having conducting traces being part of the electrode means.

6. A display device as claimed in claim 4, characterized in that the conducting traces extend substantially perpendicularly to the channel.

7. A display device as claimed in claim 2, characterized in that the channel comprises a plurality of subsequent cells, and the electrode means comprise a second electrode between one of the cells and an adjacent one of the cells, said second electrode being provided with electron beam passing apertures.

8. A display device as claimed in claim 7, characterized in that the second electrode cooperates with the first electrode for modifying the electric potential in a selected cell of the channel, so as to extract the electron beam from said selected cell towards the display screen.

9. A display device as claimed in claim 8, characterized in that the selected cell comprises an electron optical mirror.

10. A display device as claimed in claim 5, characterized in that the electrode means comprise a third electrode near a beam extraction aperture in the second insulating plate.

11. A display device as claimed in claim 1, characterized in the display device is provided with two electron sources located at opposing ends of the channel.

12. A display device as claimed in claim 1, characterized in that the display screen comprises a plurality of picture elements, and the electron beam guiding means comprise positioning means for positioning the electron beam extracted from the selected cell onto an associated picture element.

13. A display device as claimed in claim 12, characterized in that one of the subsequent cells is associated with a picture element of the display screen, and the positioning means comprise a plurality of conducting plates being provided with apertures for passing the electron beam from said one of the subsequent cells to the associated picture element.

14. A display device as claimed in claim 13, characterized in that the positioning means comprise a stack of alternating insulating and conductive plates.

15. A display device as claimed in claim 12, characterized in that one of the subsequent cells is associated with a plurality of picture elements, the positioning means comprising selection means for positioning the electron beam onto a preselected one of said plurality of picture elements.
